(19) United States
(12) Patent Application Publication
(10) Pub. No.: US 2003/0018488 A1
(43) Pub. Date: Jan. 23, 2003

(54) System and method for storing and processing data using a mobile telephone

(76) Inventors: Mehdi Elhaoussine, Aix-en-Provence (FR); Nam-Hai Tran Van Bang, Marseille (FR)

Correspondence Address: BANNER & WITCOFF, 1001 G STREET N W, SUITE 1100, WASHINGTON, DC, 20001, US

(21) Appl. No.: 10/181,720

(22) PCT Filed: Nov. 21, 2001
(86) PCT No.: PCT/FR01/03664

(30) Foreign Application Priority Data
Nov. 22, 2000 (FR) 00/15094

(51) Int. Cl. G06F 17/60

(52) U.S. Cl. 705/1

(57) ABSTRACT

The invention concerns a system (1) and a device for storing and processing data during a purchasing operation by a consumer. The system comprises at least a mobile tool (2) provided with a keyboard (15) associated with the consumer and at least a sales outlet terminal (4), the mobile tool and the terminal comprising means (9, 10) for exchanging data between them during the purchasing operation. The mobile tool further comprises means (3) for storing the consumer's behavioural and loyalty data means (13) for updating said behavioural and loyalty data based on data derived from the terminal and means for transmitting to said terminal data corresponding to said update and displaying and navigating means (14, 8, 15). The terminal comprises means for transmitting benefits obtained when certain predetermined conditions are fulfilled on the data corresponding to said update.

The present invention relates to a system for storing and processing data making it possible to store, process and consult data during a purchase operation by a user furnished with a mobile telephone or with a digital assistant, this being so as to obtain benefits for example after a certain number of visits to one or more traders, or else after purchasing a certain number of articles or a minimum cumulative amount of spending within a given period.

It also relates to a method of storing and processing data with mobile telephone or digital assistant.

It finds an especially important although nonexclusive application in the field of loyalty programs intended to encourage consumers to return to the same trader or traders.

Loyalty systems making it possible to obtain a discount, a voucher or a gift after x visits, y articles purchased or z francs spent are already known.

The encouragement can, for example, be effected through a card made of paper or cardboard which must be stamped or punched at each transaction.

There are also solutions with cards with a magnetic strip or barcode cards used with a payment terminal, where the behavioral data (frequency and/or number of visits to the same trader, or to a group of traders, cumulative amounts spent over a specified or unspecified period of time, etc.) are stored on a centralized server.

Finally, more recently, solutions with chip cards have been developed, where the history of purchases and the rights of the customer are stored and processed in the chip of the card. The known technology makes it possible for example to store numerous loyalty programs in a chip card.

Known devices or systems such as these do however exhibit drawbacks.

Specifically, they are either of low performance, or still require the use of a card to be presented to the customer.

Moreover, they do not enable the consumer to easily ascertain his rights and his purchase history in detail.

The present invention will make it possible to alleviate these drawbacks by proposing a system for storing, for processing and for consulting data within the framework of a loyalty program, which is better suited than those previously known to the requirements of the art in particular in that it puts in place an infrastructure allowing optimized management of the behavioral data which condition the obtaining of a voucher.

By virtue of the invention, the consumer will take advantage, with his portable telephone or his digital assistant, of loyalty programs at traders. He can thus receive benefits in the form of discount vouchers or promotional offers into his telephone or his digital assistant itself.

The term benefit is understood to mean either a voucher, which is printed and/or displayed on a screen, or else one or more loyalty points and/or any other promotional offer.

Thus a portable tool (portable telephone or digital assistant), a mass-market instrument, enables the consumer to participate in the loyalty program of traders.

For his part, the trader will use the portable tool of the consumer himself to store information and behavioral data concerning him, which will condition the issuing of benefits, without having to create a specific storage medium such as a loyalty card.

The portable telephone or the digital assistant are in fact secure portable objects distributed in bulk, which offer many more possibilities than a simple card.

The portable telephone and the digital assistant are moreover connected instruments, equipped with a keypad and with a screen, which will be able to be used to allow the consumer to access the information relating to his purchase history and his rights.

Consultation of the purchase history and of the rights may henceforth be carried out in real time, at any moment, without complex administrative proceedings, without even resorting to any additional device.

Finally, the trader gains from all the previous benefits, which enable him to maximize his chances of obtaining the consumer's loyalty.

With this aim the invention proposes in particular a system for storing and processing data during a purchase operation by a consumer, characterized in that it comprises at least one mobile tool (mobile telephone or digital assistant) furnished with a keypad associated with said consumer and at least one point of sale terminal,

in that the mobile tool and the terminal comprise means for exchanging data between themselves in the course of said purchase operation,

in that the mobile tool comprises means for storing consumer behavior and loyalty data, means for updating these behavior and loyalty data as a function of data originating from the terminal and means for transmitting to said terminal, data corresponding to this updating,

in that the terminal comprises means for issuing benefits in the case of compliance with certain predetermined conditions regarding the data corresponding to this updating,

and in that the mobile tool comprises means for navigating and displaying the user's behavior and loyalty data using the keypad of the mobile tool.

In advantageous embodiments one and/or other of the following provisions are moreover all also resorted to:

the system comprises a network of remote servers and the mobile tool and/or the point of sale terminal comprise means of transmission for communicating with said network and for displaying on the screen of the mobile tool and/or of the terminal, data relating to the consumer's purchase history and/or his rights to a reduction, gifts and other bonuses;

the means of transmission between the mobile tool and the terminal are at least in part means for transmitting and receiving radioelectric or infrared waves;

the means of transmission comprise, integrated into the mobile tool, means for receiving voice or digital messages, means for transmitting these voice or digital messages to the network of servers, said network of servers comprising means for converting said voice messages into digital data and for processing said digital data messages;

the means for transmitting voice or digital messages are so to an internet address and comprise means allowing the direct dialing of said address from the keypad of the mobile tool;

the system comprises means of automatic calling of the mobile tool by the network of remote servers in the case of connection of the mobile tool with the point of sale terminal.

The invention also proposes a method of storing and processing data during a purchase operation by a consumer furnished with a mobile tool furnished with a keypad, in the presence of a point of sale terminal, characterized in that:

consumer behavior and loyalty data are stored in a memory of the mobile tool,

the amount of the purchase and information required for the updating of the behavior and loyalty data are transferred to the mobile tool, from the terminal, said data are updated as a function of a specified algorithm,

updated data are transferred to the terminal, from the mobile tool, and

a benefit is issued from the terminal in favor of the consumer.

Advantageously, the consumer displays the behavioral and loyalty data relating to him by navigating using the keypad of said mobile tool.

Again advantageously, the data are transmitted between the mobile tool and the terminal by radioelectric or infrared waves.

In an advantageous embodiment, the data updating algorithm is transmitted to the terminal by way of a centralized network of information servers.

Also advantageously, the benefit is issued via display on a screen belonging to the terminal and/or in the form of paper vouchers.

In another advantageous embodiment, the benefit is issued and it is stored in the memory of the mobile tool for subsequent use.

Also advantageously, data relating to the consumer's purchase history and/or to his rights to benefits are issued from said network of servers and are displayed on the screen of the mobile tool and/or of the terminal.

In another advantageous embodiment, a voice or digital message is transmitted to an internet electronic mail address via connection with the internet network by dialing said electronic address directly from the keypad of the mobile tool or automatically by way of the terminal or otherwise.

In the embodiment more especially described, there is provision for dynamic allocation of one or several loyalty programs in the memory of the telephone.

Thus, when a card bearer visits a point of sale corresponding to a brand label for the first time, the terminal, which begins communicating with the telephone or equivalent, is designed to verify that the latter is indeed furnished with the loyalty program of the brand label.

In the case of a negative response, it transmits information which will update the identifier of the program in the memory of the telephone, as well as the behavioral data, which will be able to be incremented in the memory space provided for this purpose. It is therefore possible to dynamically manage the activation of the loyalty program in the telephone.

The present invention will be better understood on reading the description which follows of embodiments given by way of nonlimiting examples.

It refers to the drawings which accompany it and in which:

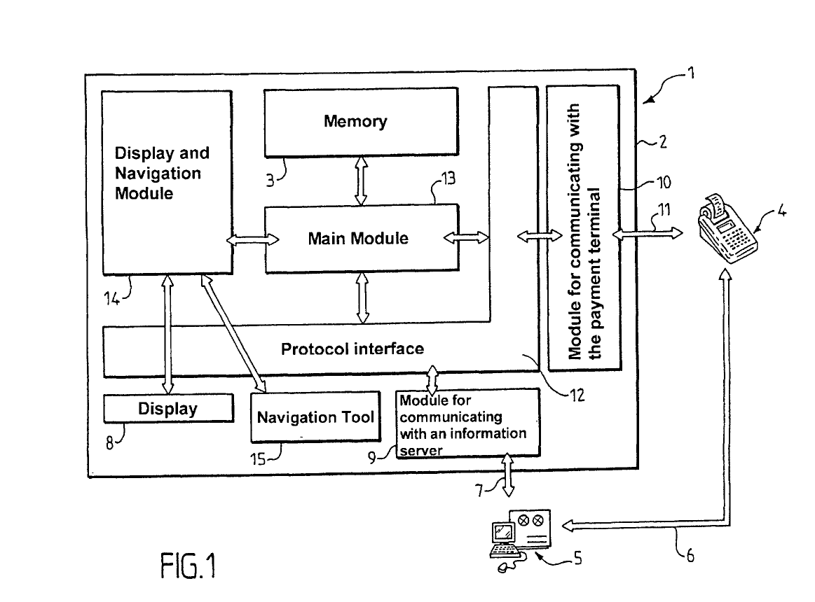

FIG. 1 is a diagrammatic view of the system according to one embodiment of the invention.

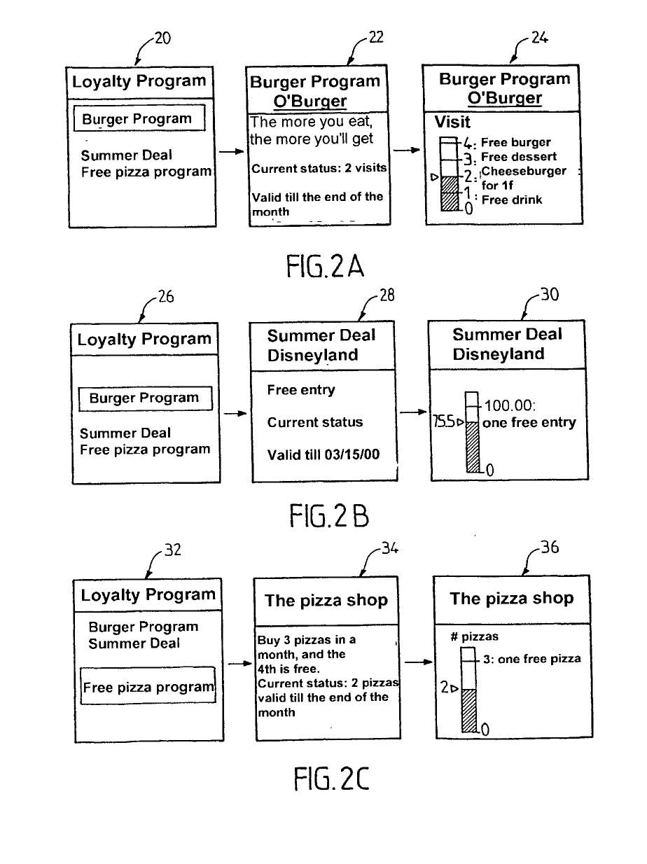

FIGS. 2A to 2C give examples of consultation screens of a mobile telephone used within the framework of an embodiment of the invention.

FIG. 1 shows a system 1 comprising a mobile tool 2, for example a mobile telephone, furnished with a data memory 3 (SIM card and/or its own memory) and a point of sale terminal 4 consisting here of a payment terminal.

The point of sale terminal can also be different, for example a kiosk, an automatic dispenser, etc.

In the embodiment more especially described here, the system 1 also comprises one or more remote servers 5, of PC type, affording the functions of:

transmission of the loyalty parameters to the payment terminal (double arrow 6),

collection of the data relating to the loyalty transactions (double arrow 6),

transmission to the mobile tool 1 (double arrow 7) of the data required for the consultation on a screen or display 8 of the mobile tool 2, of the information relating to the obtaining of benefits (purchase history and rights).

To do this, the mobile tool 1 comprises electronic modules 9 and 10 for communicating (double arrows 6 and 11) with the information server(s) 5 on the one hand and with the payment terminal 3 on the other hand. These modules are known in themselves and allow communication by infrared waves (diodes, etc) and/or radioelectric waves (transmitter/receiver etc.).

To allow the various elements of the system to understand one another, the tool comprises interface means 12 comprising one or more protocols for communication between the mobile tool 1, the payment terminal 4 and/or the servers 5, for example one or more of the following transmission protocols:

SMS (Short Message Service), allowing the tool to talk to the payment terminal when the latter is equipped with a GSM module,

“Bluetooth” (exchange by radio frequency), “Bluetooth” is a short-range wireless transmission standard, known to the person skilled in the art. Let us recall that at present, equipment implementing this standard can communicate with one another within a radius of the order of ten meters with bit rates of 1 Mbits/s.

IrDa (standard for communication by infrared),

all other standards, such as the new GPRS, UMTS, Wap standards, etc.

The mobile tool also comprises a main module 13, comprising a processor implementing the necessary software, affording in particular the following functions:

exchange of information between the payment terminal and the portable telephone (module 10),

storage and updating of the data in the portable telephone (module 3),

reading and interpretation of the loyalty information at the level of the terminal (double arrow 11),

issuing of the vouchers at the level of the terminal 4,

display and screening (module 14) of the purchase history and of the rights of the consumer on the screen or display 8 of the portable telephone via a navigation tool 15 comprising a keypad for example formed by a digital liquid crystal screen.

An exemplary application of the method according to the invention will now be described together with a loyalty program which issues targeted vouchers based on the cumulative amount of the purchases.

This program will moreover be summarized in the table hereinbelow.

The objective to be achieved is to bring about an increase in the amount of the purchases under a brand label of the relevant trader or traders.

To do this, use is made of a loyalty program based on proportional rules related to the amount of the purchases made within the month.

The issuing of the electronic vouchers in the mobile tool is performed in real time at the level of the payment terminal, when the consumer has reached the desired reward threshold.

In the example described here, the program consists of four scenarios which correspond to increasing thresholds of reward.

The rules of issue and the content of the program are as follows:

Receive a drink for $15 worth of purchases or more.

Receive a T-shirt for $40 worth of purchases or more. 20% discount on selected records for $75 worth of purchases or more.

Receive a meal in the store restaurant for $120 worth of purchases or more.

TABLE giving the details of the way the program works
and of the conditions for issuing vouchers:

| | Program #1 |
|---|---|
| Type of program: | Cumulative amount |
| Date of validity: | From 01 January to 31 December |
| Period: | Monthly |
| Name of trader: | Megatunes |
| Name of program | “Megadeal” |
| Slogan: | “The more you buy, the more |
| | you get!!” |
| No. of vouchers: | 4 |
| Voucher #1 | |
| Lower limit: | $15 |
| Upper limit: | $39.99 |
| Conditions of issue | First time |
| Description: | “Coupon for a free drink at |
| | the cafeteria” |
| Voucher #2 | |
| Lower limit: | $40.00 |
| Upper limit: | $17.99 |
| Conditions of issue | First time |
| Description | “Receive a T-shirt” |
| Voucher #3 | |
| Lower limit: | $75.00 |
| Upper limit: | $119.99 |
| Conditions of issue | First time |
| Description | “20% discount on selected |
| | records” |
| Voucher #4 | |
| Lower limit: | $120.00 |
| Upper limit: | — |
| Conditions of issue | First & Reset |
| Description: | “Receive a meal in the store |
| | restaurant” |

FIGS. 2A to 2C give screen examples displayable on a mobile tool (for example a portable telephone) allowing consultation of the status (behavioral data) of the consumer (purchase and right history) in various programs set up by traders, and implementing the invention.

The conditions for obtaining the vouchers are displayed explicitly on the screen of the portable telephone.

More precisely, FIG. 2A gives an exemplary program based on a frequency of monthly visits.

The screens 20, 22 and 24 show successively the selecting of the program “Burger”, (screen 20) by the consumer using the conventional means of navigation, the current status together with the period of validity (screen 22) and the displaying of the benefit received or to be received by the consumer (screen 24) on a scale.

FIG. 2B gives an exemplary program based on the cumulative amount of the purchases.

The screens 26, 28 and 30 display the selecting of the “Summer Deal” program, the current status, taking into account purchases, being shown visually on the screen 30.

Finally, FIG. 2C shows an exemplary program based on the number of products purchased within the month (here pizzas).

The screens 32, 34 and 36 display the selecting of the free pizza program (screen 32), the current status (screen 34) and the displaying of the benefit on a scale (screen 36).

An example of the working of the system according to the embodiment of the invention more especially envisaged here, together with a portable telephone 2, at a trader furnished with a payment terminal 4 will now be described with reference to FIG. 1.

When a consumer comes to a point of sale and makes a purchase, the amount of the transaction and the information required for updating the data in the portable telephone 1 are transmitted by the terminal 4.

Initialization of the communication (arrow 11) between the portable telephone 1 and the terminal 4 is performed for example by simply pointing (point-to-point communication) in the case of an infrared link.

In the case of “Bluetooth” technology, identification and synchronization between the two instruments is achieved by frequency negotiation within a master/slave type relationship.

Finally, the case of communication by short message requires the dialing of a telephone number in order to set up the link and the exchange of information (for example the consumer dials his telephone number on the keypad of the trader's payment terminal).

The communication between the terminal 4 and the portable telephone 1 is effected by virtue of the module for communication 10 via the protocol interface 12. The Main Module 13 retrieves the information transmitted by the terminal 4 and updates the behavioral data in the Memory 3.

Next, the Main Module 13 sends back the cumulative data which condition the issuing of benefit to the payment terminal 4.

If the criteria for issue are validated the terminal 4 issues the benefit via simple display on the screen or by printing the latter.

In an advantageous process there is provision for storing the benefit in the actual Memory 3 of the portable telephone for subsequent use.

Transmission of the loyalty parameters to the terminal 4 and remote collection of transactions from the terminal is achieved here by virtue of one or more Centralized Information Servers 5, via the link 6 for example by way of the internet network, or by satellite.

For consultation purposes, the Main Module 13 accesses the information contained in the Memory 3 of the telephone 2. When the information contained in the memory is exhaustive, it distributes these data to the Display and Navigation Module 14.

However, also advantageously, when the information contained on the Memory 3 are partial, the Main Module 13 obtains the missing information by means of remote interrogation of the Information Server 5 by way of the Communication Module 9 and of the Protocol Interface 12. The Main Module 13 then compares the information from the Memory 3 with that originating from the Server 5, then distributes it to the Display and Navigation Module 14.

After receipt of these data, the Display and Navigation Module 14 shapes them and transmits them to the Display 8 for screening. These data can then be consulted by the bearer by means of the Navigation Tool 15, for example a keypad.

A mode of embodiment of the data files which can be used with the invention has been described hereinbelow by way of example.

The General File:

This contains the information describing the telephone and/or the operator, and in particular:

an identification number for the portable telephone and/or for the SIM card,

the name of the operator (or an identifier allowing retrieval thereof),

the date of validity of the subscription,

The Consumer File:

This groups together the information describing the telephone owner, such as:

the name of the owner,

an identification number for the bearer (such as a subscription number),

demographic information, such as the date of birth, his/her address, etc.,

biometric information, such as the bearer's size, etc.,

The so-called RFA (Recency Frequency Amount) File:

This stores the history of the purchase behavior for each of the traders frequented by the owner of the portable telephone. It is structured into records, each record containing the information peculiar to the loyalty program(s) of a trader (or of several when the loyalty program is common to several traders).

Each Record Contains:

an identification number for the loyalty program,

the type of loyalty program carried out by this trader,

the date of expiry of the loyalty program,

the date of the last visit made to this trader,

the number of visits made to this trader,

the cumulative amount of the purchases made from this trader.

In certain cases the cumulative number of articles purchased from this trader (e.g.: # pizzas).

The Vouchers File:

This makes it possible to store the benefit issued at the level of the terminal in the memory of the telephone for subsequent use thereof. Among the information contained in this file would be inter alia and for example:

an offer identifier and/or a voucher identification code

the date of validity of the voucher

the descriptive text or wording of the voucher

an identifier for the acceptance network

The Points File:

This stores the cumulation of loyalty points acquired by the owner of the portable telephone at one or more traders, should the benefit take the form of an issuing of loyalty points of promotional unit type which can be cumulated and exchanged on presentation for a reward.

As goes without saying and as indeed follows from the foregoing the present invention is not limited to the embodiment more especially described. On the contrary it embraces all those which follow and in particular those where the benefits presented to the consumer in the form of electronic vouchers are downloaded into his portable or digital assistant by the decoder of a television during the screening of television programs.

1. A system (1) for storing and processing data during a purchase operation by a consumer, comprising at least one mobile tool (2) furnished with a keypad (15) associated with said consumer and at least one point of sale terminal (4),
the mobile tool (2) and the terminal (4) comprising means (10) for exchanging data between themselves in the course of said purchase operation, characterized in that the mobile tool comprises means (3) for storing consumer behavior and loyalty data, means (13) for updating these behavior and loyalty data as a function of data originating from the terminal (4) and means for transmitting to said terminal, data corresponding to this updating,
in that the terminal comprises means (14) for issuing benefits in the case of compliance with certain predetermined conditions regarding the data corresponding to this updating,
and in that the mobile tool comprises means (14, 8, 15) for display and navigation which make it possible to navigate around the user's behavior and loyalty data on using the keypad (15) of the mobile tool.

2. The system as claimed in claim 1, characterized in that it comprises a network of remote servers (5) and in that the mobile tool (2) and/or the point of sale terminal (4) comprise means (12, 9, 13) of transmission for communicating with said network and for displaying on the screen (8) of the mobile tool (2) and/or of the terminal (4), data relating to the consumer's purchase history and/or his rights to a reduction, gifts and other bonuses.

3. The system as claimed in either of the preceding claims, characterized in that the means (9, 10) of transmission between the mobile tool and the terminal are at least in part radioelectric or infrared.

4. The system as claimed in either of claims 2 and 3, characterized in that the means of transmission comprise, integrated into the mobile tool, means for receiving voice or digital messages, means for transmitting these voice or digital messages to the network of servers, said network of servers comprising means for converting said voice messages into digital data and for processing said digital data messages.

5. The system as claimed in claim 4, characterized in that the means for transmitting voice or digital messages are so to an internet address and comprise means allowing the direct dialing of said address from the keypad of the mobile tool.

6. The system for communication according to any one of claims 2 to 5, characterized in that it comprises means of automatic calling of the network of remote servers (5) in the case of connection of the portable telephone with the point of sale terminal.

7. A method of storing and processing data during a purchase operation by a consumer furnished with a mobile tool (2) furnished with a keypad (15), in the presence of a point of sale terminal (4), characterized in that:
consumer behavior and loyalty data are stored in a memory (3) of the mobile tool,
the amount of the purchase and information required for the updating of the behavior and loyalty data are transferred to the mobile tool (2), from the terminal (4),
said data are updated as a function of a specified algorithm,
updated data are transferred to the terminal, from the mobile tool, and
a benefit is issued from the terminal in favor of the consumer in the case of compliance with certain predetermined conditions regarding the data corresponding to this updating.

8. The method of storage and processing as claimed in claim 7, characterized in that, the data are transmitted between the mobile tool (2) and the terminal (4) by radioelectric or infrared waves.

9. The method as claimed in either of claims 7 and 8, characterized in that the benefit is issued via display on a screen belonging to the terminal (4).

10. The method as claimed in any one of claims 7 to 9, characterized in that the benefit is issued in the form of paper vouchers.

11. The method as claimed in either of claims 7 and 8, characterized in that the benefit is issued and it is stored in the memory (3) of the mobile tool for subsequent use.

12. The method as claimed in any one of claims 7 to 11, characterized in that the terminal (4) and/or the mobile tool (2) is/are connected to a network of remote servers (5) for transmission of the data updating algorithm.

13. The method as claimed in any one of claims 7 to 12, characterized in that the terminal (4) and/or the portable telephone is/are connected to a remote network of servers and data relating to the consumer's purchase history and/or to his rights to benefits are issued from said network of remote servers and are displayed on the screen of the mobile tool and/or of the terminal.

14. The method as claimed in either of claims 12 and 13, characterized in that a connection is made with the network of remote servers by transmitting a voice or digital message to an internet electronic mail address via connection with the internet network by dialing said electronic address directly from the keypad of the mobile tool or automatically by way of the terminal or otherwise.
